(19) United States
(12) Patent Application Publication
(10) Pub. No.: US 2012/0312458 A1
(43) Pub. Date: Dec. 13, 2012

(54) APPARATUS FOR LABELLING

(76) Inventors: Kevin Andrew Auton, Cambridge (GB); Michael Andrew Beadman, Cambridge (GB); Jeremy Peter Clements, Cambridge (GB)

(21) Appl. No.: 13/501,667

(22) PCT Filed: Oct. 11, 2010
(86) PCT No.: PCT/GB10/51702

§ 371 Date: Jul. 26, 2012

(30) Foreign Application Priority Data
Oct. 13, 2009 (GB) 0917883.1
Mar. 25, 2010 (GB) 1005010.2

(51) Int. Cl. B65C 9/08; B32B 38/10

(52) U.S. Cl. 156/212; 156/767; 156/719; 156/443

(57) ABSTRACT

We describe a peel and present mechanism (10) for use with labelling apparatus such as a label stock cartridge or cassette, or a label printer. The peel and present mechanism is configured to peel labels (18) from label stock (14) having a backing liner (16). The mechanism comprises a first, label stock carrying face bounded by a label-detachment edge (12,20) wherein, in use, said label stock passes in a longitudinal direction over said label stock carrying face and around said label-detachment edge (20) to peel and present labels (18), and wherein said label stock carrying face has a bent transverse surface profile (24) in a transverse direction perpendicular to said longitudinal direction such that, in use, said label stock is bent in said transverse direction whereby, as said label stock passes over said-label detachment edge, said longitudinal direction of said label stock defines a projected path for a label peeled from said label stock by said label-detachment edge.

### FIELD OF THE INVENTION

This invention relates to a peel-and-present mechanism for use in apparatus for labelling such as a label stock cartridge or cassette, or a label printer; and to corresponding methods.

### BACKGROUND TO THE INVENTION

Traditional label peel and present mechanisms use a number of methods to separate the label from its liner these include:
Using the stiffness of the label to overcome the strength of the adhesive to the liner material when the liner is peeled over a straight edge
Using a scraper to lift the label from the liner
Using excessive tension on the liner material to pull the liner around a sharp angle

When the labels are very thin, floppy or ‘pre-curled’ the low stiffness of the label can result in reliability issues when a label is pulled around th leading edge without peeling away from the liner or excessive tension leading to tears and breaks in the liner.

There is a particular problem in labelling tubes of very small diameter, for example of the type employed for clinical samples such as blood samples. This is because the labels need to be very thin to wrap well around a curved surface of small radius of curvature, and to stay wrapped at sample storage temperatures which may, for example, be around −80° C. Moreover such labels may be “pre-curled”, for example by means of layers with different in-built stress, in order that the labels naturally curl around the sample tube on removeable from their backing tape (“liner”); an example of such label stock is the B-490 Freezer Bondz(™) label stock from Brady Corporation, UK. Background prior art can be found in the following documents: U.S. Pat. No. 4,626,313; U.S. Pat. No. 6,231,253; U.S. Pat. No. 2,602,719; U.S. Pat. No. 3,330,207; U.S. Pat. No. 3,415,706; U.S. Pat. No. 3,468,739; U.S. Pat. No. 3,530,028; U.S. Pat. No. 3,586,878; U.S. Pat. No. 3,941,278 Label dispensing machine; U.S. Pat. No. 4,435,243 Deposit information labelling mechanism for ATM envelope depositing equipment; U.S. Pat. No. 4,560,087 Label peeling device for label issuing machine; U.S. Pat. No. 4,626,313 Manual label applicator; U.S. Pat. No. 4,826,558 Electrically-operated labeller; U.S. Pat. No. 5,009,739 Hand-held labeller; U.S. Pat. No. 5,040,461 Label printing and dispensing apparatus; U.S. Pat. No. 5,108,534 Apparatus and method for peeling a sheet or layer from a workpiece; U.S. Pat. No. 5,169,474 Apparatus and method for de-laminating a composite laminate structure; U.S. Pat. No. 5,209,374 Label dispenser for self-adhesive labels arranged on separate sheets; U.S. Pat. No. 5,395,174 Apparatus for printing labels; U.S. Pat. No. 5,427,460 Label printer and label strip feed mechanism therefore; U.S. Pat. No. 5,478,428 Label separator and method for separating a label from a backing; U.S. Pat. No. 5,520,776 Method and apparatus for delaminating a laminate; U.S. Pat. No. 5,658,416 Method and apparatus for peeling a laminate; U.S. Pat. No. 5,713,679 Apparatus for selectively dispensing liner-type and linerless-type labels; U.S. Pat. No. 5,716,492 Tape cutter and self-adhesive label peeler; U.S. Pat. No. 5,718,525 label printer and dispenser; U.S. Pat. No. 5,730,816 Selective label stripping method and apparatus; and U.S. Pat. No. 5,800,669 Labeller; U.S. Pat. No. 4,089,730; GB1563892A; and in particular in CA1032907A.

### SUMMARY OF THE INVENTION

According to the present invention there is therefore provided a peel and present mechanism for use with apparatus for labelling, said peel and present mechanism being configured to peel labels from label stock having a backing liner, said peel and present mechanism comprising a first, label stock carrying face bounded by a label-detachment edge wherein in use said label stock passes in a longitudinal direction over said label stock carrying face and around said label-detachment edge to peel and present labels, and wherein said label stock carrying face has a bent or shaped transverse surface profile in a transverse direction perpendicular to said longitudinal direction.

In preferred embodiments the peel and present mechanism is such that, in use, said label stock is bent in said transverse direction whereby, as said label stock passes over said-label detachment edge, said longitudinal direction of said label stock defines a projected path for a label peeled from said label stock by said label-detachment edge. Broadly speaking, the inventors have recognised that a label, in particular a thin label, can be made temporarily stiffer by curving or folding the label stock so that the labels have a tendency to continue to project in the longitudinal direction defined by the label stock carrying face as the backing liner is drawn around the label detachment edge.

The bent transverse surface profile may comprise one or more curves or “V”-shapes and, in principle any transverse surface profile which is not a straight line should be effective, for example a simple curved bow shape. However in some preferred embodiments wherein the label detachment edge is a sharp edge (for example defined by a pair of faces which meet along an edge) with a V-shaped transverse profile. These features provide significant advantages in starting and controlling label peel, which is especially important for the thin labels used when labelling tubes of small diameter. Providing the sharp edge in combination with a V-shaped profile facilitates starting the label peel: For thin labels there is a tendency for labels to remain attached to their backing—the backing tape is relatively thick and the labels are very thin and flexible and absent these features have a tendency to simply follow their backing tape (liner) along its path.

Preferably the label stock carrying face is indented so that the bent transverse surface profile rises towards longitudinal edges of the label stock carrying face as in this way the labels are peeled away from the backing first at their edges, more specifically their front corners rather than in the middle thus facilitating label release.

In preferred embodiments a label stock guide is also provided, positioned over the label stock carrying face and having a complimentary bent transverse surface profile to that of the label stock carrying face to thereby define a slot for guiding the label stock. This assists in the operation of the peel and present mechanism. The label stock guide may, but need not necessarily be attached to the peel and present mechanism.

In preferred implementations of the mechanism the label detachment edge is bent when viewed along a third axis perpendicular to both the longitudinal direction and to the transverse direction. Preferably this bending is such that a path length along the label stock carrying face and over the label detachment edge is substantially constant over at least a portion of the width of the label stock carrying face in the transverse direction, preferably over a width equal to a width of the label stock intended for use with the mechanism. This can be understood by considering a label-detachment edge which is not bent in this way for example an edge which is left by cutting a transverse section through the label stock carrying face. In travelling over such an edge the backing liner would have less far to travel at the centre of the U- or V-shaped indention than when travelling over the raised edges, thus straining the label stock. For very narrow or flexible label stock this may not be a problem, but, preferably, the label detachment edge has a profile which, when viewed along the third axis, approximately or substantially matches a scaled version of the transverse surface profile of the label stock carrying face (the scaling factor depends upon how far back on itself the backing liner is folded as it travels around the label detachment edge, that is on the angle between the portion of the label stock travelling towards the label detachment edge and the portion of the backing liner travelling away from the label detachment edge after a label has been peeled off).

In some preferred embodiments however the apparatus includes an automatic label stock centring mechanism to automatically centre the label stock on the label stock carrying face. Thus in some preferred embodiments the label detachment edge is shaped such that a path length along said label stock carrying face and over said label-detachment edge is (slightly) longer in a centre of said label stock carrying face than to either side (that is than at locations towards either longitudinal edge of the label stock carrying face).

The label stock carrying face may be provided on what may be termed a beak of the peel and present mechanism. In some embodiments the peel and present mechanism may be generally triangular or wedge-shaped with one face defining the label stock carrying face; in this way the peel and present mechanism may be integrally formed from a single piece of material such as a metal or polymer. Alternatively the beak of the peel and present mechanism may be fabricated as a suitably shaped plate, for example a metal plate, attached to a mount within the apparatus for labelling. Thus the beak of the peel and present mechanism may comprise a projecting metal surface or plate, shaped as described above.

The peel and present mechanism may be built into a label stock cartridge or cassette, in particular so that the beak comprises part of the label outlet of the device. Alternatively the mechanism may be built into a label printer. In either case, in some preferred embodiments the label stock is preferably held in tension over the label detachment edge, for example by a take-up spool or by a pair of rollers following the peel and present mechanism (in a direction of travel of the label stock/backing liner).

Thus in a related aspect the invention provides a method of peeling labels from label stock and presenting the peeled labels along a defined projected path, the method comprising: stiffening said label stock by curving or folding said label stock in a longitudinal direction; and transporting said label stock in tension along said longitudinal direction and around a label detachment edge such that said labels detach from a backing liner of said labelling stock and continue in said longitudinal direction, said longitudinal direction defining said projected path, whilst said backing liner travels on away from said projected path; and preferably further comprising approximately or substantially equalising tension across a width of said labelling stock by shaping said label detachment edge to compensate for said curving or folding of said labelling stock.

In a further related aspect the invention provides apparatus for peeling labels from label stock and presenting the peeled labels along a defined projected path, the apparatus comprising: means for stiffening said label stock by curving or folding said label stock in a longitudinal direction; means for transporting said label stock in tension along said longitudinal direction and around a label detachment edge such that said labels detach from a backing liner of said labelling stock and continue in said longitudinal direction, said longitudinal direction defining said projected path, whilst said backing liner travels on away from said projected path; and wherein said detachment edge is shaped to compensate for a curve or fold in said labelling stock defined by said stiffening means, in particular to thereby approximately or substantially equalise tension across a width of said labelling stock.

In the above described method and apparatus preferably the detachment edge is shaped to approximately or substantially match a scaled version of a curve or fold in said labelling stock defined by said stiffening means. However it is further preferable that the detachment edge is shaped such that a tension in a longitudinally central region of said label stock is (slightly) greater than a tension in said label stock to either side of said longitudinally central region. This helps to provide an automatic centring mechanism for the label stock.

In embodiments the apparatus is configured for labelling a curved surface having a radius of curvature of less than 15 mm, and the label detachment edge is a sharp edge with a V-shaped transverse profile as previously described. Then the apparatus may further comprise means for applying the label to the curved surface and, preferably, means for capturing a peeled label between the curved surface and a pinch roller. In embodiments the pinch roller grips the tube and an adhesive side of the label sticks to the tube such that rotation of the tube pulls the label back and applies the label to the tube. Optionally the apparatus may further comprise a moveable clamping roller for holding the tube in place and/or at least one roller following the label detachment edge in a direction of travel of the backing liner for tensioning said label stock over the label detachment edge.

Thus preferred embodiments of the above described methods and apparatus are particularly useful for labelling a curved surface having a radius of curvature of less than 15 mm, 10 mm or 7 mm. Similarly embodiments of the above described methods and apparatus are particularly useful for peeling very thin labels, for example having a thickness of less than 150 μm, 100 μm, 80 μm or 60 μm, in particular plastic labels (such as polyester labels) and/or “pre-curled” labels. Such techniques are particularly useful for labelling clinical/biological sample tubes, especially labelling for storage at less than 0° C., −20° C., −40° C., −60° C. or −80° C. and/or that are suitable for exposure to liquid nitrogen temperatures (−196° C.).

In a further aspect the invention provides a method of dispensing a label detachably adhered to a liner forming label stock, said method comprising: pulling the label stock over a label stock carrying face toward a label detachment edge defining an edge of the label stock carrying face transverse to the direction of label stock travel, said label stock carrying face having a concave profile forming a profile in the label and liner of the label stock stiffening the label carried by the liner of the label stock, said label having a middle portion interposed between longitudinal edges; and pulling said label stock over said label detachment edge causing said longitudinal edges of said label to separate from said liner prior to separation of said middle portion of said label from said liner along said label detachment edge.

In embodiments the method includes balancing variances in tension in the liner across the width of the label detachment edge due to the profile formed in the liner by the label stock carrying face by pulling the label stock over the label detachment edge having a convex profile enabling substantially equal path lengths along the length of the liner. Preferably the concave profile includes a V-shape and the convex profile of the label detachment edge includes a sharp edge with a V-shaped transverse profile.

The method may further include balancing variances in tension in the liner due to the profile formed in the liner by the label detachment edge by pulling the label stock over a liner carrying face extending from the label detachment edge at a non-zero angle relative to the label stock carrying face, the liner carrying face having a convex profile enabling substantially equal path lengths along the length of the liner to balance variances in tension in the liner across the width of the liner carrying face due to the profile formed in the liner by the label stock carrying face.

The invention still further provides a peel and present mechanism for peeling a label off of a liner of a label stock, said mechanism comprising: a label stock carrying face having a concave profile forming a profile in the label and liner of the label stock stiffening the label carried by the liner of the label stock, said label having a middle portion interposed between longitudinal edges; a label detachment edge defining an edge of the label stock carrying face transverse to the direction of label stock travel over said label detachment edge, said label detachment edge having a convex profile enabling substantially equal path lengths along the length of the liner to balance variances in tension in the liner across the width of the label detachment edge due to the profile formed in the liner by said label stock carrying face, said concave profile of said label stock carrying face causing said longitudinal edges of said label to separate from said liner prior to separation of said middle portion of said label from said liner along said label detachment edge.

In embodiments the mechanism includes a liner carrying face extending from the label detachment edge at a non-zero angle relative to the label stock carrying face, the liner carrying face carrying the liner away from the label detachment edge, the liner carrying face having a convex profile enabling substantially equal path lengths along the length of the liner to balance variances in tension in the liner across the width of the liner carrying face due to the profile formed in the liner by the label detachment edge.

In some preferred embodiments the concave profile includes a V-shape and the convex profile of the label detachment edge includes a sharp edge with a V-shaped transverse profile.

### BRIEF DESCRIPTION OF THE DRAWINGS

These and other aspects of the invention will now be further described, by way of example only, with reference to the accompanying figures in which:

FIG. 1 shows an isometric view of a profiled edge peel and present device according to an embodiment of the invention;

FIG. 2 shows an end view showing a profiled ‘peeling’ edge;

FIG. 3 shows an isometric view highlighting equal path lengths of label across the liner;

FIG. 4 shows an isometric view showing a male convex clamp for additional forming of the labels and liner;

FIG. 5 shows a top view of the peel and present mechanism showing straight projection of the label;

FIG. 6 shows an outline view of a label printer incorporating the mechanism;

FIG. 7 shows a close up view of the labeller mechanism; FIG. 8 shows a label stock path through the printer; and

FIG. 9 shows an automatic label stock centring mechanism according to an embodiment of the invention.

### DETAILED DESCRIPTION OF PREFERRED EMBODIMENTS

Broadly speaking, we will describe a peel and present system 10 for a label printer or other labelling system for separating labels from backing liner and presenting the labels to a user or secondary mechanism. The apparatus passes the label and liner between profiling faces 12 or edges to enhance the shape of the label and liner 14 prior to peeling. The backing strip 16 is then peeled around a specially profiled edge 20 and collected on a spool. The label 18 continues in a controlled straight trajectory from the profiled edge without flopping. A profile surface 24 is provided on a return path for the liner.

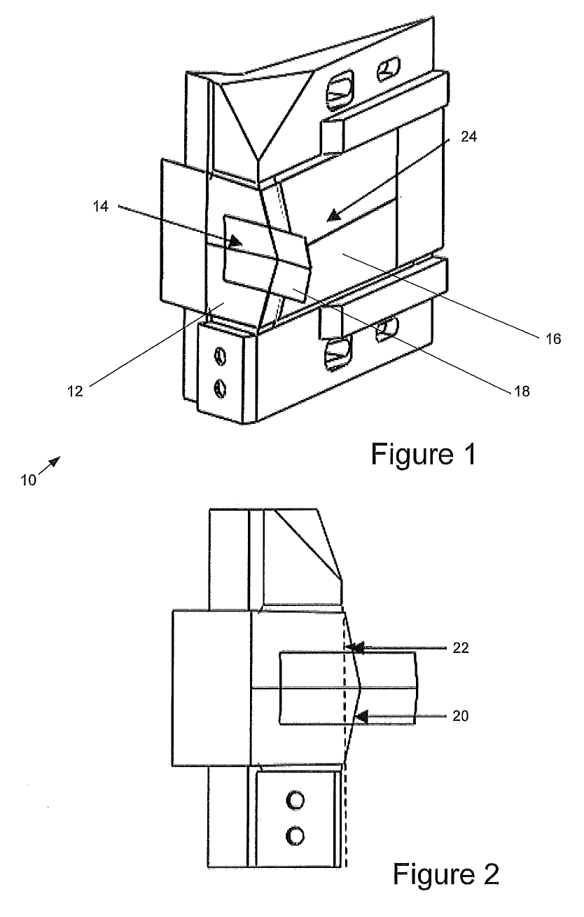

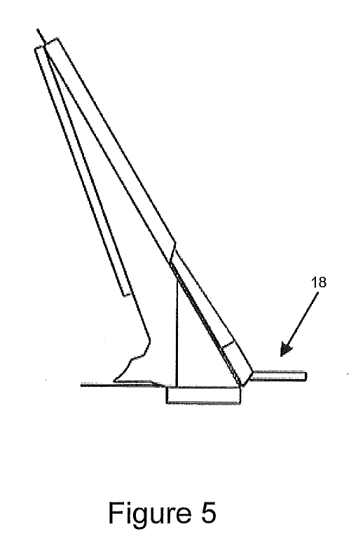

Referring to FIGS. 1 to 5 a preferred embodiment of the invention works by introducing a profile into the label and liner material to change the shape of the label, temporarily increasing the stiffness of the label enabling it to separate from the liner material. The change of shape is enabled by a special profile on the leading edge of the peel mechanism to enable equal path lengths along the length of the liner minimising stress and preventing jamming and tearing.

In this design the label and liner are formed past a profiled face 12 (curved or angled) increasing the second moment of area of the label and liner and therefore the stiffness. This increase in stiffness enables the peeling and presenting of very thin, floppy or “pre curled” labels to be promoted away from the backing strip or liner and projected in a straight line.

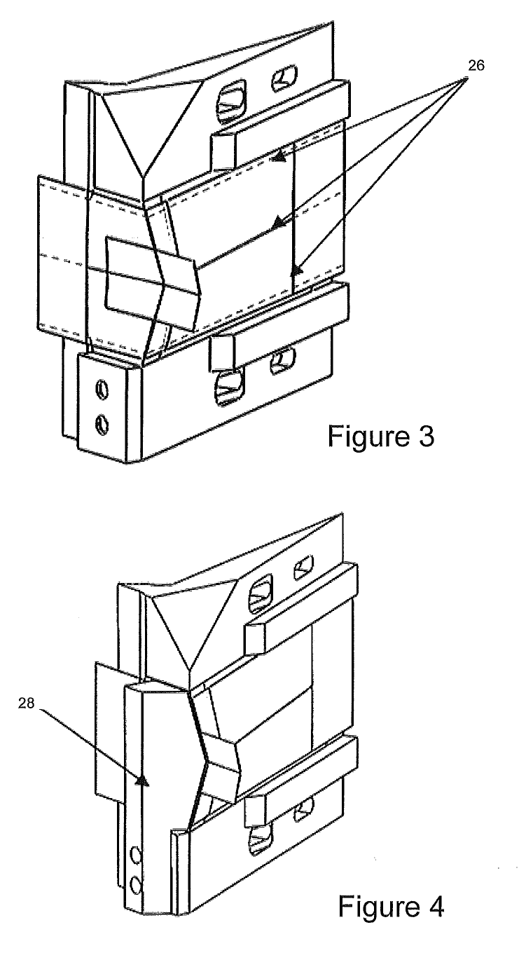

The liner is folded backwards over a specifically profiled leading edge 20 which maintains the path length of the backing strip at all points across the liner material. In FIG. 2 dashed line 22 shows a line of transverse section across the label stock carrying face. In FIG. 3 dashed lines 26 show paths of equal length due to the geometry of the ‘peeling’ curve (label detachment edge). If the liner is peeled back along a simple plane then due to the interaction between a non flat-surface and an angled plane the formed edge could create excessive tension parts of the liner leading to jamming and tearing. To overcome this problem the leading edge of the peeling mechanism is profiled to minimise the stress in the liner and therefore reducing the risk of jams and tearing. An additional aid to promote the forming of the label and liner without unnecessary tension is the use of an additional convex or male profile clamp (label stock guide) 28 to maintain the stiffer shape of the liner and label.

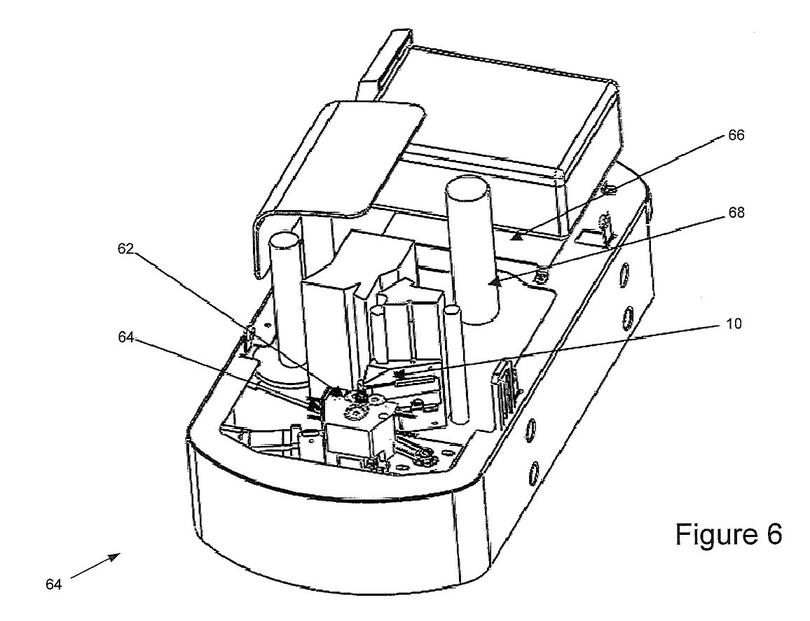

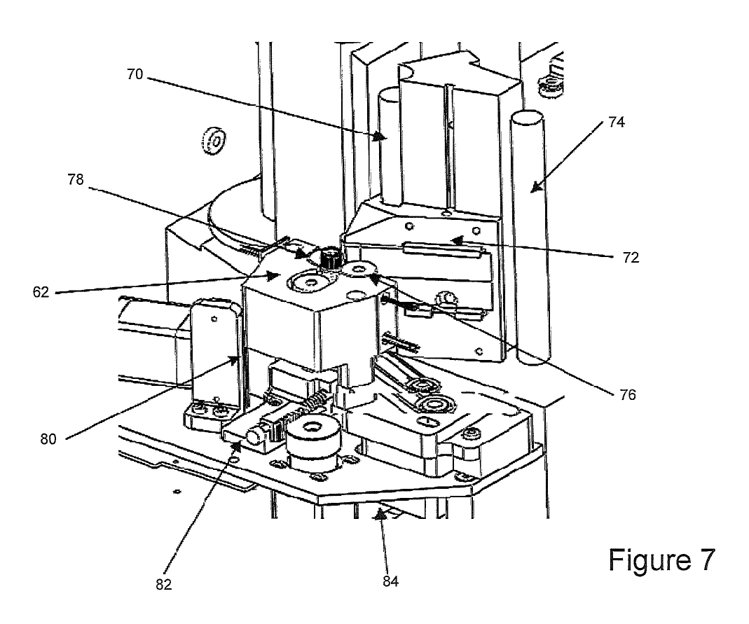

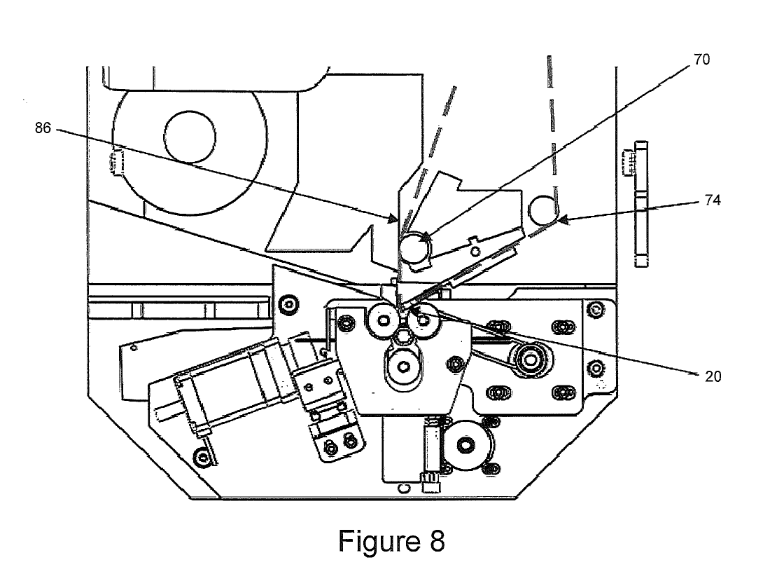

FIG. 6 shows the peel and present mechanism 10 in one possible application for labelling tubes. The label printer 60 comprises a roller mechanism 62, a tube detection system 64, a backing liner and label holder 66 and a backing liner storage post 68. As the labels are presented by the novel mechanism presented above they are fed into the further mechanism holding and rotating a tube or vial. As the tube rotates the leading edge of the label is pinched onto the surface of the tube and as the tube rotates the label is applied around the circumference of the tube. FIG. 7 shows a close up of this particular mechanism and FIG. 8 shows the vertical view of the label path. FIG. 7 shows a label liner drive roller 70 to push the liner into the peel and present mechanism; a peel and present beak 72; a drive roller 74 to maintain tension on the liner and pull this through the beak; a drive roller 76 for the tube rotating system; a pinch roller 78 to apply the peeled label to the tube; a tube lifting mechanism 80; a clamping roller mechanism 82; and a barcode reader 84 mounted vertically below the tubes. FIG. 8 shows drive roller 70 pushing the label liner into the peel and present mechanism 10, driver roller 74 pulling the label through the peel and present mechanism, peel and present edge 20 to separate the label from the liner and project the label into the roller mechanism 62; and a print head 86 to apply information to the label. The operation can be described in the following order. The label and backing liner are pulled by a pinch roller towards a print head where the label is printed. The same pinch roller then feeds the label stock towards the peel and present beak.

The geometry of the beak shapes the label into the stiffer form and the backing label is peeled back over the novel edge profile described in this patent. The backing liner is pulled away by a second pinch roller and stored on a spool. The label itself with its new shape and increased stiffness is projected forwards in the original trajectory that it took into the beak. The increased stiffness allows a significant projection of the label (about 15 mm) into the tube rolling mechanism where it meets the tube. In this case the tube has been hand inserted into a system of three rollers to define a fixed position for the tube to rotate. Different tube diameters are accommodated by one movable clamping roller. The tube is driven to rotate by one drive roller and the label is projected between the tube and another pinch roller. The pinch grips the tube and then the adhesive side of the label will stick to the tube. The rotation of the tube pulls the label through the mechanism smoothing and applying the label to the tube. Once the label is applied, the clamping roller retracts and the tube can be removed from the mechanism. An additional component in this mechanism is a barcode reader underneath the tube which can read a barcode present on the tube. This barcode information can then be linked in a database to the information printed on the label.

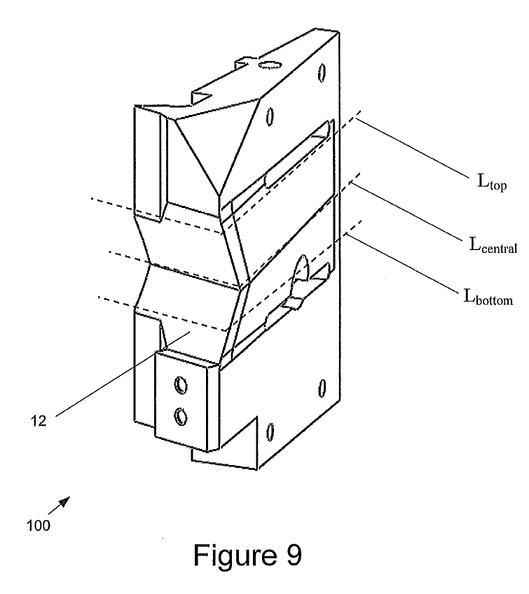

Referring now to FIG. 9, this shows an example of a peel-and-present mechanism 100 incorporating an automatic label stock centring or self-tracking mechanism to automatically centre or track the label stock on the label stock carrying face. The path length at the centre of the web (label backing stock) travelling across the label stock carrying face is marginally longer than the outside. To apply this to the beak of FIG. 1 there a small geometry change to lengthen the central path length (L_{central}). This will marginally increase tension and stress on the material but if the length increase remains small and the stress within the elastic limit of the material then there will not be sufficient force to tear or jam the label backing stock. This improvement increases the stability of the beak and improves placement tolerances of any printing on the label.

No doubt many other effective alternatives will occur to the skilled person. It will be understood that the invention is not limited to the described embodiments and encompasses modifications apparent to those skilled in the art lying within the spirit and scope of the claims appended hereto.

1. A peel and present mechanism for use with apparatus for labelling, said peel and present mechanism being configured to peel labels from label stock having a backing liner, said peel and present mechanism comprising a first, label stock carrying face bounded by a label-detachment edge wherein, in use, said label stock passes in a longitudinal direction over said label stock carrying face and around said label-detachment edge to peel and present labels, and wherein said label stock carrying face has a shaped transverse surface profile in a transverse direction perpendicular to said longitudinal direction such that, in use, said label stock is bent in said transverse direction wherein, as said label stock passes over said-label detachment edge, said longitudinal direction of said label stock defines a projected path for a label peeled from said label stock by said label-detachment edge, wherein said label detachment edge is shaped such that a path length along said label stock carrying face and over said label-detachment edge is longer in a centre of said label stock carrying face than to either side.

2. A peel and present mechanism as claimed in claim 1 wherein said shaped transverse surface profile rises towards longitudinal edges of said label stock carrying face.

3. A peel and present mechanism as claimed in claim 1 or 2 wherein said shaped transverse surface profile has a V-shaped profile.

4. (canceled)

5. (canceled)

6. (canceled)

7. (canceled)

8. (canceled)

9. A peel and present mechanism as claimed in claim 1 further comprising a label stock guide positioned over said label stock carrying face and having a complementary bent transverse surface profile to said label stock carrying face to define a slot therebetween for guiding said label stock.

10. Apparatus for labelling comprising the peel and present mechanism of claim 1.

11. (canceled)

12. (canceled)

13. (canceled)

14. (canceled)

15. A method of peeling labels from label stock and presenting the peeled labels along a defined projected path, the method comprising:
stiffening said label stock by curving or folding said label stock in a longitudinal direction; and
transporting said label stock in tension along said longitudinal direction and around a label detachment edge such that said labels detach from a backing liner of said labelling stock and continue in said longitudinal direction, said longitudinal direction defining said projected path, whilst said backing liner travels on away from said projected path, wherein tension in a longitudinally central region of said label stock is greater than a tension in said label stock to either side of said longitudinally central region.

16. (canceled)

17. A method of labelling a curved surface having a radius of curvature of less than 15 mm, the method comprising peeling labels from labelling stock as claimed in claim 15, capturing a said peeled label in one or more pinch rollers, and applying said label to said curved surface.

18. A method as claimed in claim 15, wherein said label detachment edge is a sharp edge with a V-shaped transverse profile.

19. (canceled)

20. (canceled)

21. Apparatus for peeling labels from label stock and presenting the peeled labels along a defined projected path, the apparatus comprising:
means for stiffening said label stock by curving or folding said label stock in a longitudinal direction;
means for transporting said label stock in tension along said longitudinal direction and around a label detachment edge such that said labels detach from a backing liner of said labelling stock and continue in said longitudinal direction, said longitudinal direction defining said projected path, whilst said backing liner travels on away from said projected path; and
wherein said detachment edge is shaped such that a tension in a longitudinally central region of said label stock is greater than a tension in said label stock to either side of said longitudinally central region.

22. (canceled)

23. (canceled)

24. Apparatus as claimed in claim 21, for labelling a curved surface having a radius of curvature of less than 15 mm, wherein said label detachment edge is a sharp edge with a V-shaped transverse profile.

25. Apparatus as claimed in claim 21 for labelling a curved surface having a radius of curvature of less than 15 mm, further comprising means for capturing a said peeled label between said curved surface and a pinch roller, and means for applying said label to said curved surface.

26. (canceled)

27. (canceled)

28. (canceled)

29. (canceled)

30. A method of dispensing a label detachably adhered to a liner forming label stock, said method comprising:
pulling the label stock over a label stock carrying face toward a label detachment edge defining an edge of the label stock carrying face transverse to the direction of label stock travel, said label stock carrying face having a concave profile forming a profile in the label and liner of the label stock stiffening the label carried by the liner of the label stock, said label having a middle portion interposed between longitudinal edges; and
pulling said label stock over said label detachment edge causing said longitudinal edges of said label to separate from said liner prior to separation of said middle portion of said label from said liner along said label detachment edge.

31. The method as in claim 30, including balancing variances in tension in the liner across the width of the label detachment edge due to the profile formed in the liner by said label stock carrying face by pulling the label stock over said label detachment edge having a convex profile enabling substantially equal path lengths along the length of the liner.

32. The method as in claim 31, in which said concave profile includes a V-shape and said convex profile of said label detachment edge includes a sharp edge with a V-shaped transverse profile.

33. The method as in claim 31, including balancing variances in tension in the liner due to the profile formed in the liner by said label detachment edge by pulling the label stock over a liner carrying face extending from said label detachment edge at a non-zero angle relative to said label stock carrying face, said liner carrying face having a convex profile enabling substantially equal path lengths along the length of the liner to balance variances in tension in the liner across the width of the liner carrying face due to the profile formed in the liner by said label stock carrying face.

34. A peel and present mechanism for peeling a label off of a liner of a label stock, said mechanism comprising:
a label stock carrying face having a concave profile forming a profile in the label and liner of the label stock stiffening the label carried by the liner of the label stock, said label having a middle portion interposed between longitudinal edges;
a label detachment edge defining an edge of the label stock carrying face transverse to the direction of label stock travel over said label detachment edge, said label detachment edge having a convex profile enabling substantially equal path lengths along the length of the liner to balance variances in tension in the liner across the width of the label detachment edge due to the profile formed in the liner by said label stock carrying face, said concave profile of said label stock carrying face causing said longitudinal edges of said label to separate from said liner prior to separation of said middle portion of said label from said liner along said label detachment edge.

35. The mechanism as in claim 34, including a liner carrying face extending from said label detachment edge at a non-zero angle relative to said label stock carrying face, said liner carrying face carrying said liner away from said label detachment edge, said liner carrying face having a convex profile enabling substantially equal path lengths along the length of the liner to balance variances in tension in the liner across the width of the liner carrying face due to the profile formed in the liner by said label detachment edge.

36. The mechanism as in claim 35, in which said concave profile includes a V-shape and said convex profile of said label detachment edge includes a sharp edge with a V-shaped transverse profile.

37. The mechanism as claimed in claim 34 further comprising a label stock guide positioned over said label stock carrying face and having a complementary bent transverse surface profile to said label stock carrying face to define a slot therebetween for guiding said label stock.

38. The apparatus as claimed in claim 21 wherein the means for stiffening said label stock comprise a label stock guide positioned over a label stock carrying face, the label stock guide having a complementary bent transverse surface profile to said label stock carrying face to define a slot therebetween for guiding said label stock.
